(19) United States
(12) Patent Application Publication
(10) Pub. No.: US 2025/0344100 A1
(43) Pub. Date: Nov. 6, 2025

(54) METHOD OF UE INFORMATION REPORTING

(71) Applicant: ZTE Corporation, Shenzhen (CN)

(72) Inventors: Xiubin SHA, Shenzhen (CN); Bo DAI, Shenzhen (CN); Yuan GAO, Shenzhen (CN); Eswar Kalyan VUTUKURI, Shenzhen (CN)

(73) Assignee: ZTE Corporation, Shenzhen, GD (CN)

(21) Appl. No.: 19/272,781

(22) Filed: Jul. 17, 2025

Related U.S. Application Data
(63) Continuation of application No. PCT/CN2023/086714, filed on Apr. 6, 2023.

(51) Int. Cl. H04W 28/02; H04L 43/065

(52) U.S. Cl. CPC H04W 28/0278; H04L 43/065; H04W 28/0236

(57) ABSTRACT

The present disclosure describes techniques for delay reporting of buffered data in a wireless communication system. A buffered data delay reporting indication is transmitted to a user equipment (UE). A delay report of buffered data is received from the UE identifies: a duration from an occasion a packet arrived in the buffer to an occasion where the delay report was transmitted, a duration from the occasion a packet arrived in the buffer to an occasion indicated by a reference time, a remaining duration from the occasion where the delay report was transmitted an occasion an access network packet delay budget is reached, a remaining duration from an occasion indicated by the reference time to the occasion an access network packet delay budget is reached, or a duration from the occasion the delay report was transmitted to an expiration time of a packet discard timer.

### CROSS-REFERENCE TO RELATED APPLICATIONS

The present application is a continuation of International Application No. PCT/CN2023/086714, filed Apr. 6, 2023. The contents of International Application No. PCT/CN2023/086714 are herein incorporated by reference in their entirety.

### TECHNICAL FIELD

The present subject matter is directed generally to wireless communications. Particularly, the present subject matter relates to methods, devices, and systems for user equipment (UE) information reporting, including delay reporting of buffered data in uplink and unused configured grant (CG) occasion reporting.

### BACKGROUND

When a UE delivers uplink (UL) packets, the following procedure may be carried out: (1) the UE may report the buffer size level by reporting the quantity of UL packets in the UE buffer via a buffer status report (BSR) medium access control (MAC) control element (CE); (2) the radio network element may allocate a UL grant for the UE based on the received BSR and the access network packet delay budget (AN PDB); and (3) the UE may send the UL packets over the allocated UL grant. Based on this procedure, when the radio network element allocates the UL grant for the UE, it cannot know the length of time the UL packet has been buffered in the UE before the UE sends the BSR nor how much remaining time, as may be limited by the AN PDB or discard timer (e.g., discardTimer), may be used for the transmission. If the radio network element allocates the UL grant based on the AN PDB without considering the time that the UL packet has been buffered in the UE, the UL packet transmission delay from when the packet is sent from the UE packet data convergence protocol layer (PDCP) to when the packet arrives at the radio network element may exceed the AN PDB. Thus, the UL transmission may not satisfy the service requirement.

Additionally, periodic CG resource(s) and/or multiple CG occasion(s) (e.g., Multiple Configured Grant (CG) PUSCH transmission occasions) within one CG periodicity (e.g., a period of a single CG PUSCH configuration) may be configured for UL transmission for low latency. If there is no further data to be transmitted on the CG resource(s) and/or CG occasion(s), the UE may send the information on unused CG resource(s) and/or unused CG occasion(s) to the next generation Node B (gNB) to release the configuration so that the CG resource(s) and/or unused CG occasion(s) can be used for other purposes. The techniques described herein in accordance with the present subject matter may address reporting this information to the gNB.

### SUMMARY

The present subject matter is directed to a method, device, and system for delay reporting of buffered data in uplink and unused CG occasion reporting to a gNB.

In some embodiments, a method for delay reporting of buffered data in a wireless communication system comprising a user equipment (UE) having a buffer and a base station is provided, the method includes transmitting a buffered data delay reporting indication to the UE; and receiving a delay report of buffered data from the UE, wherein the delay report of buffered data identifies one or more of: a first time duration from a first occasion a packet arrived in the buffer to a second occasion in which the delay report of buffered data was transmitted, a second time duration from the first occasion a packet arrived in the buffer to a third occasion that is indicated by a reference time, a first remaining time duration from the second occasion in which the delay report of buffered data was transmitted to the base station to a third occasion that an access network packet delay budget (AN PDB) is reached, a second remaining time duration from a fourth occasion that is indicated by the reference time to the third occasion that an AN PDB is reached, a third time duration from the second occasion the delay report of buffered data was transmitted to an expiration time of a packet discard timer, or a fourth time duration from the fourth occasion that is indicated by the reference time to the expiration time of the packet discard timer.

In some embodiments, a method for delay reporting buffered data in a wireless communication system comprising a user equipment (UE) having a buffer and a base station is provided, the method includes: receiving a buffered data delay reporting support indication from the UE; transmitting a buffered data delay reporting configuration to the UE that configures a report type to a periodical report or an event report; and receiving a delay report of buffered data based on the configured report type, wherein the delay report of buffered data identifies one or more of: a first time duration from a first occasion a packet arrived in the buffer to a second occasion in which the delay report of buffered data was transmitted, a second time duration from the first occasion a packet arrived in the buffer to a third occasion that is indicated by a reference time, a first remaining time duration from the second occasion in which the delay report of buffered data was transmitted to the base station to a third occasion that an access network packet delay budget (AN PDB) is reached, a second remaining time duration from a fourth occasion that is indicated by the reference time to the third occasion that an AN PDB is reached, a third time duration from the second occasion the delay report of buffered data was transmitted to an expiration time of a packet discard timer, or a fourth time duration from the fourth occasion that is indicated by the reference time to the expiration time of the packet discard timer.

In some embodiments a method of releasing resources in a wireless communication system comprising a user equipment (UE) and a base station is provided, the method includes: receiving information specifying an unused resource from the UE; and releasing the unused resource in response to the information.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example wireless communication system including a wireless base station and user equipment.

FIG. 2 shows an example of a base station.

FIG. 3 shows an example of user equipment.

FIG. 4 shows a swim lane diagram of an example delay reporting indication communication between a gNB 200 and a UE 300.

FIG. 5 shows a swim lane diagram of an example send delay reporting support capability communication between a gNB 200 and a UE 300.

FIG. 6A shows an example timing diagram of an unused CG occasion indication.

FIG. 6B shows an example timing diagram of an unused CG occasion indication.

FIG. 6C shows an example timing diagram of an unused CG occasion indication.

FIG. 6D shows an example timing diagram of an unused CG occasion indication.

FIG. 6E shows an example timing diagram of an unused CG occasion indication.

### DETAILED DESCRIPTION

The present subject matter will now be described in detail hereinafter with reference to the accompanied drawings, which form a part of the present subject matter, and which show, by way of illustration, specific examples of embodiments. Please note that the present subject matter may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures, or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

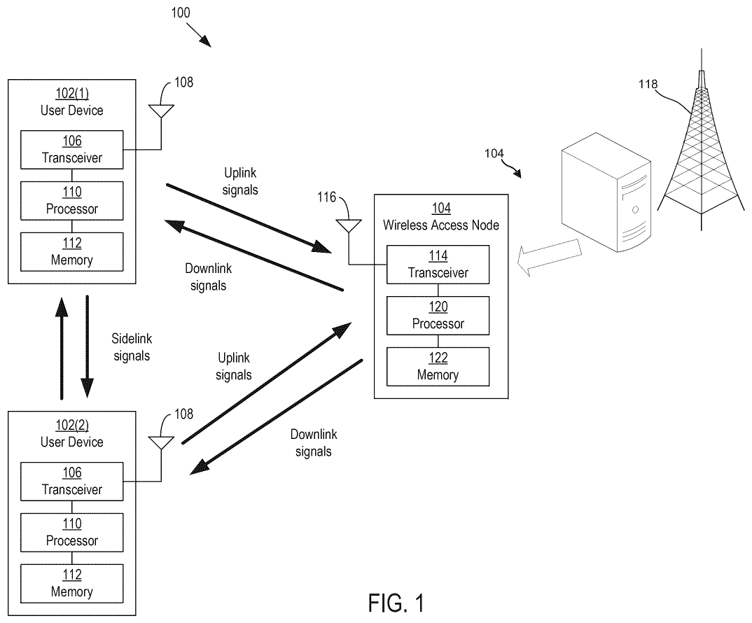

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless communication system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition, or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless communication system 100, the communication nodes are configured to wirelessly communicate signals between each other. In general, a communication in the wireless communication system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless communication system 100 can both send and receive signals, a single communication node may be both a transmitting/source node and a receiving/destination node simultaneously or switch between being a source/transmitting node and a destination/receiving node.

Also, particular signals may be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the wireless communication system 100 may be characterized or defined as a data signal or a control signal. In general, a data signal is a signal that includes or carries data, such multimedia data (e.g., voice and/or image data), and a control signal is a signal that carries control information that configures the communication nodes in certain ways to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, in the wireless communication system 100, a slot format for a plurality of slots or frames may be configured by the wireless access node 104 or specified by a protocol. In some examples, a slot may be indicated or specified as a downlink slot, a flexible slot, or an uplink slot. Also, an orthogonal frequency divisional multiplexing (OFDM) symbol may be indicated or specified as a downlink symbol, a flexible symbol, or an uplink symbol, in various embodiments.

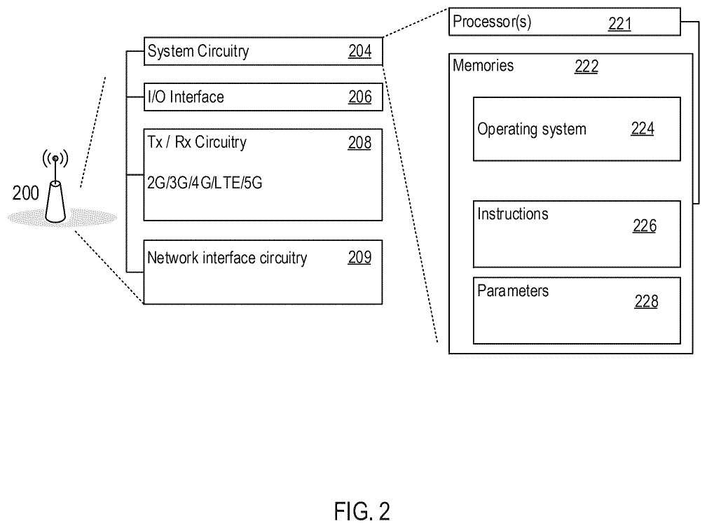

FIG. 2 shows an example of base station 200. The example base station 200 may include radio transmitting/receiving (Tx/Rx) circuitry 208 to transmit/receive communication with UEs and/or other base stations. The base station 200 may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

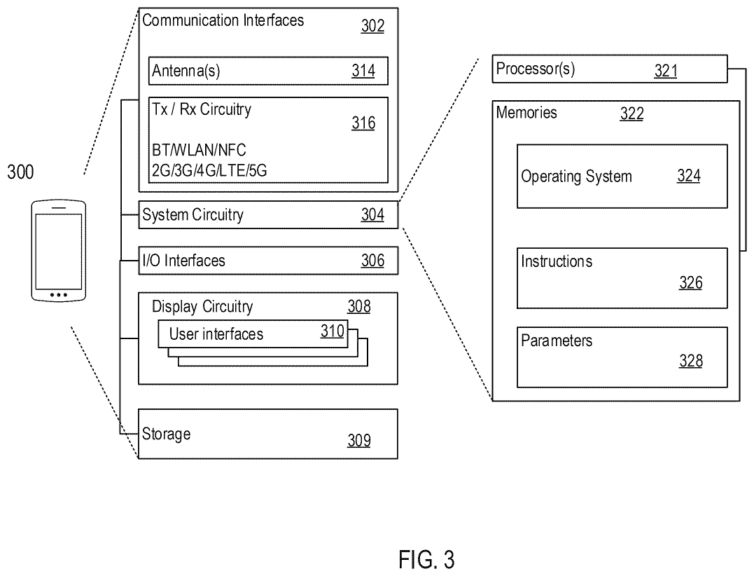

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers, and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

The system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

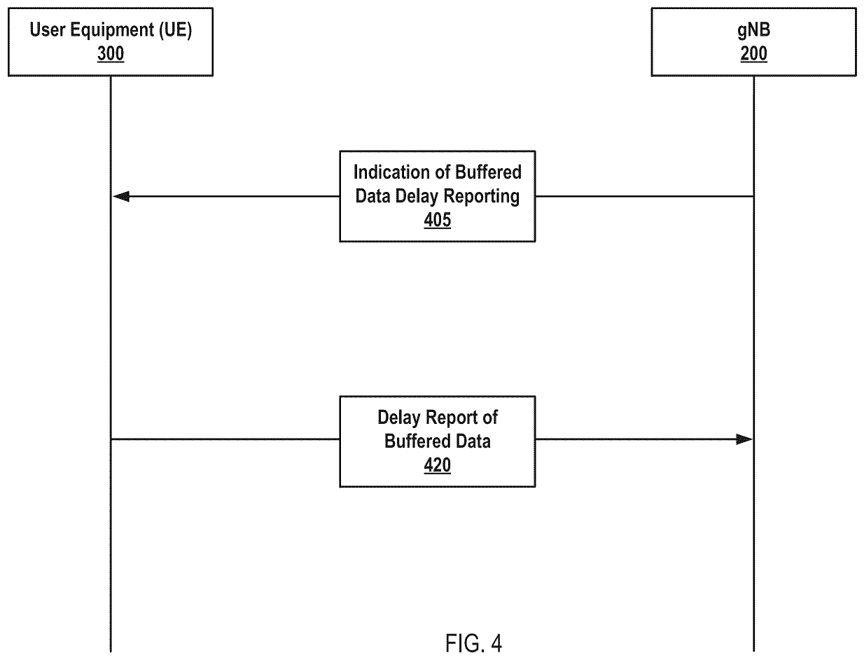

FIG. 4 illustrates a swim lane diagram of an example delay reporting indication communication between a gNB 200, also known as a base station, and a UE 300 in accordance with the present subject matter. The gNB 200 may send a buffered data delay reporting indication 405 to the UE 300. The buffered data delay reporting indication 405 may be sent to the UE 300 by a system information block (SIB) or by a unicast radio resource control (RRC) message. If sent by unicast RRC message, the reporting indication 405 may be sent per UE 300, per data radio bearer (DRB), per logical channel group (LCG), or per logical channel.

The UE 300 may send delay report of buffered data 420 to the gNB 200 associated with a BSR reporting. The UE 300 may also send the delay report of buffered data 420 to the gNB 200 using a delay report MAC CE associated with a DRB, logical channel group ID (LCGID) or logical channel ID. The delay report of buffered data 420 may identify the time duration that the buffer size may cached in the UE 300, including at least one of the following: (1) elapsed time since the packet(s) arrived at the UE PDCP or PDCP upper service access point (SAP) (i.e., the time duration from the occasion from the time the packet arrives at UE PDCP or PDCP upper SAP to the delay information reporting occasion); (2) the remaining time before the AN PDB is reached (i.e., the time duration from the delay information reporting occasion until the AN PDB expires); (3) the remaining time before the packet discardTimer expires (i.e., the time duration from the delay information reporting occasion to the discardTimer expiration); (4) the DRB ID, LCGID, or logical channel ID that the delay report of buffered data 420 corresponds to; or (5) the reference time used to calculate the time duration in the delay report of buffered data 420.

The reference time may be used to indicate the starting time point, in which the time duration of the delay report of buffered data 420 may be compared to and calculated. The reference time may be mainly used to deal with the delay report 420 retransmission case; e.g., the time duration of the delay report of buffered data 420 may be set when the delay report 420 is initially transmitted. The time duration may not be updated during the retransmission procedure. The gNB 200 may not decide the initial transmission time when the retransmission occurs. Thus, if there is no reference time, the gNB 200 cannot decide at which time that the time duration in the delay report of buffered data 420 is set, and cannot decide an accurate time to be used for UL resource scheduling. The reference time may be established as a time nearest preceding or nearest following the transmission of the delay report 420, which may be indicated by at least one of: (1) the start boundary of an indicated system frame number (SFN), (2) the end boundary of an indicated SFN, (3) the SFN number, (4) the LSB (least n significant bit) of the SFN, (5) the slot information, (6) a CG start occasion, (7) a connected mode discontinuous reception (C-DRX) start occasion, (8) a periodical delay report start occasion, or (9) a pre-defined periodical reference time (e.g., one reference time point every n radio frames, where n may be an integer number).

The delay report 420 may be retransmitted in subsequent SFNs, which may not cause the time duration to be reset. For instance, a data packet may arrive at the PDCP entity in SFN=2 and the delay report 420 may be initially transmitted when SFN=3. Then, the UE 300 may set the time duration in the delay report 420 based on a reference time of SFN=3. Thus, the gNB 200 may deduce the time duration (e.g., 10 ms) that the buffer size may be cached in the UE 300 even when the delay report 420 is received in SFN=4 or SFN=5 due to retransmissions. The retransmission(s) may not alter the reference time and calculation of the time duration.

When multiple data packets having different delays are buffered for the reporting (e.g., per LGC or per logical channel), the most rigid value for resource scheduling (e.g., the largest value of elapsed time or the least remaining time) may be reported.

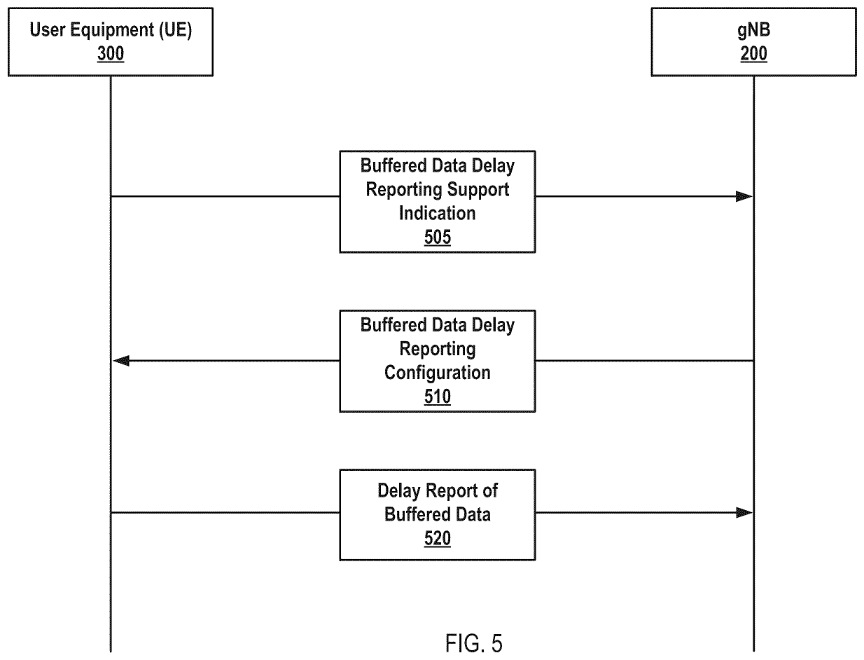

FIG. 5 illustrates a swim lane diagram of an example send delay reporting support capability communication between a gNB 200 and a UE 300. The UE 300 may send a buffered data delay reporting support indication 505 to the gNB 200. The buffered data delay reporting support indication 505 may be sent via a UECapabilityInformation message. The gNB 200 may respond by sending a buffered data delay reporting configuration 510 to the UE 300. The reporting configuration 510 may be configured to a report type of a periodical report and/or an event report. The reporting configuration 510 may be configured per UE 300, per DRB, per LCG, or per logical channel.

When the report type is set to a periodical report, the report periodicity may be configured by the buffered data delay reporting configuration 510. The UE 300 may send the delay report of buffered data 520 to the gNB 200 if there is data (e.g., data packets) buffered for the reporting (e.g., per LCG or per logical channel). The UE 300 may also send the delay report of buffered data 520 to the gNB 200 using a delay report MAC CE associated with a DRB, LCGID or logical channel ID. When multiple data packets having different delays are buffered for the reporting (e.g., per LCG or per logical channel), the most rigid value for resource scheduling (e.g., the largest value of elapsed time or the least remaining time) may be reported.

When the report type is set to an event report, the report interval or delay report prohibit timer may be configured by the buffered data delay reporting configuration 510. The UE 300 may send the delay report of buffered data 520 to the gNB 200 when the event is triggered. The event may be: (1) BSR report triggered; (2) when the buffered time of one or more packets is larger than a preconfigured threshold; and/or (3) when the remaining time for buffered data transmission is less than a preconfigured threshold.

When the report interval is configured and after the UE 300 sends the delay report of buffered data 520 while the report condition is still satisfied, the UE 300 may send the delay report of buffered data 520 with a time interval larger than or equal to the report interval.

When the delay report prohibit timer is configured and after the UE 300 sends the delay report of buffered data 520, the delay report prohibit timer may be started or restarted. The UE 300 may not send the delay report of buffered data 520 if the delay report prohibit timer is still running or otherwise unexpired. The UE 300 may send the delay report of buffered data 520 only if the delay report prohibit timer is expired or the delay report prohibit timer is not running.

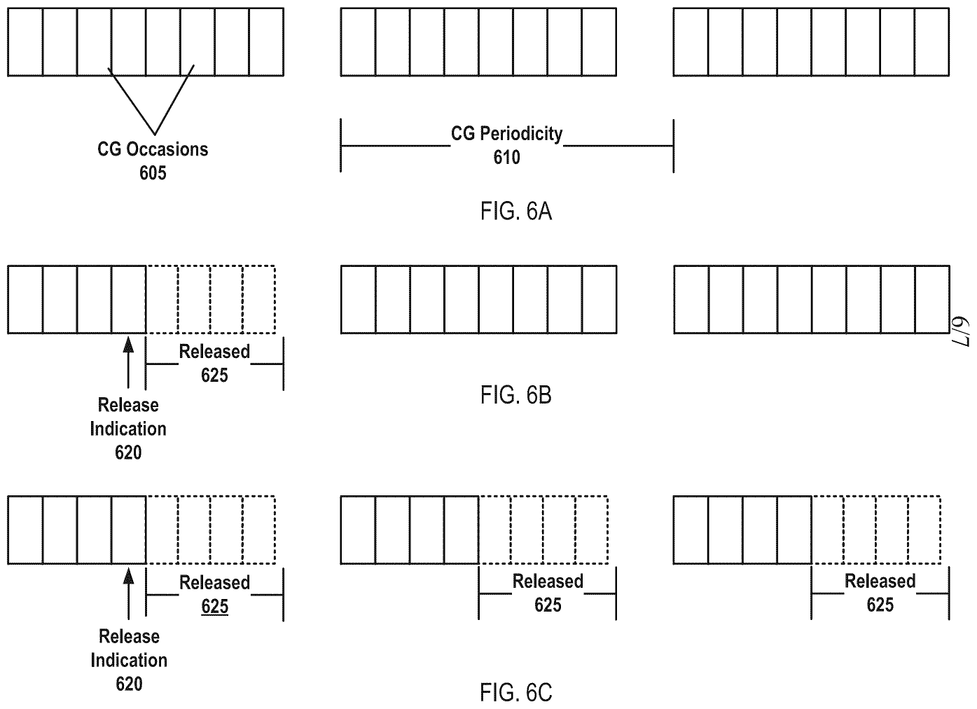

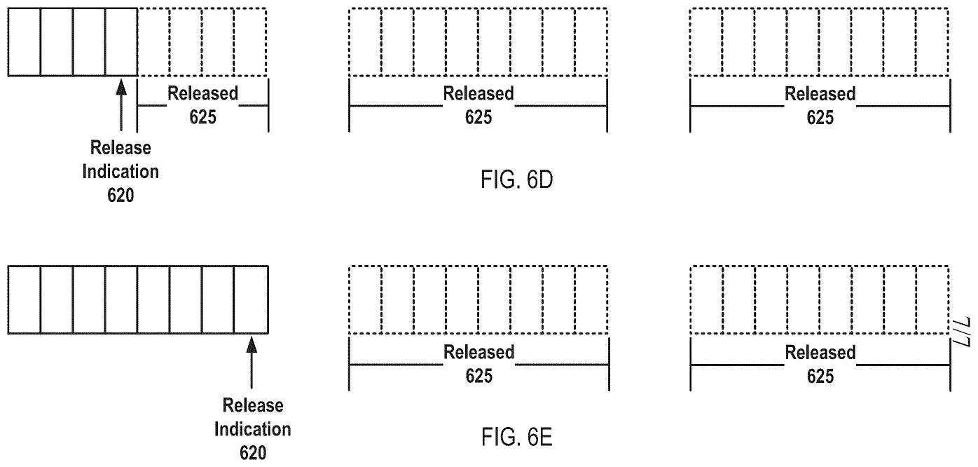

FIG. 6A shows an example timing diagram of an unused CG occasion indication. As shown in FIG. 6A, multiple CG occasion(s) 605 may be configured within one CG periodicity 610 with a CG occasion interval (e.g., the interval between the start time of two adjacent CG occasions in one CG periodicity) and a CG occasion number (e.g., the number of CG occasions in one CG periodicity) configuration. In the example of FIG. 6A, a CG periodicity 610 may include eight CG occasions 605, although other variations are possible without departing from the scope of the present subject matter.

When multiple CG occasions 605 are configured in one CG periodicity 610, the M^{th} (where M is an integer and M>=0) CG occasion in the N^{th} (where N is an integer and N>=0) CG periodicity 610 occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = ( startSFN \times numberOfSlotPerFrame \times numberOfSymbolsPerSlot + startSlot \times numberOfSymbolsPerSlot + startSymbol + N \times periodicity + M \times intervalofCG - Occasions ) modulo ( 1024 \times numberOfSlotsPerFrame \times numberOfSymbolsPerSlot )$$

$$or$$

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + startSymbol + N \times periodicity + M \times intervalofCG - Occasions ) modulo ( 1024 \times numberOfSlotsPerFrame \times numberOfSymbolsPerSlot )$$

Wherein thestartSFN, startSlot, startSymbol, or timeReferenceSFN, timeDomainOffset,startSymbol may be used to determine the start time of the 0th CG occasion in the 0th CG periodicity. The periodicity is the CG periodicity 610 configured by gNB 200. The intervalofCG-Occasions is the interval between the start time of two adjacent CG occasions 605 in one CG periodicity 610.

The HARQ process ID for M^{th} (M is an integer and M>=0) CG occasion in the N^{th} (N is an integer and N>=0) CG periodicity 610 can be decided by the following:

$$HARQ Process ID = [ nrofCG - Occasions * N + M ] modulo nrofHARQ - Processes + harq - ProcID - Offset$$

wherein:
nrofCG-Occasions is the number of CG occasions 605 in one CG periodicity 610, configured by gNB 200 (e.g. sent from gNB 200 to UE 300);
nrofHARQ-Processes is the number of configured HARQ processes for the CG and/or CG occasions 605, configured by the gNB 200 (e.g. sent from gNB 200 to UE 300); and
harq-ProcID-Offset is the offset of HARQ process, configured by gNB 200 (e.g. sent from gNB 200 to UE 300), which is used to determine the minimal HARQ process ID used for the CG and/or CG occasions 605. The default harq-ProcID-Offset is zero (e.g. if harq-ProcID-Offset is not provided).

With this method, UE 300 and gNB 200 may accurately determine the CG resource, and a different HARQ process ID may be used for different CG occasions 605 and different CG periodicity 610.

Furthermore, to assist CG and/or CG occasion(s) configuration, the following information can be provided from the UE 300 to gNB 200:
Burst size: Expected size of the individual burst. This information may be useful to configure the size of CG resource in each period. Finer granularity for burst size may be considered for components of the XR stream (e.g., I frames, P/B frames, and audio frames).
Burst size variance: expected variance of the data bursts generated. It is important to configure the resources such that resources may be neither under-configured nor over-configured. A combination of CG/DG may be used to avoid wastage of radio resources depending on the expected variance in the burst size.
Burst arrive timing: An absolute time (e.g., expressed by SFN, slot and/or symbol) or a time offset (e.g., offset to an SFN/radio frame boundary) may be included when the periodic data is generated for each period. Providing this offset may be important to tailor the radio resources (e.g., the CG period offset) such that the CG occasion 605 occurs at the right instance. If the CG resource is not configured at the right instance, there may be a residual latency, which may be as large as the CG period itself in the worst case and may be undesirable.
Burst arrive jitter: expected jitter of Burst arrive timing. It may be helpful to determine the start of the CG resources (e.g., the start time of CG periodicity 610 and CG occasions 605).

Generally, the UE 300 may send information about unused CG resource(s) (i.e., the remaining four CG occasions 605) and the related CG periodicities 610 to the gNB 200 to release the CG resources. The released CG resource(s) 625 may then be used for other purposes, such as by other UEs 300 or other services.

The UE 300 may send a UL transmission on each CG occasion 605 without PDCCH scheduling, which may save PDCCH resources and may reduce the uplink transmission delay. However, if the CG resource(s) and/or CG occasion(s) 605 are configured more than necessary, some of the configured CG resource(s) and/or CG occasion(s) 605 may be wasted. In this case, the UE 300 may send information about the unused CG resource(s) and/or the unused CG occasion(s) 605 to the gNB 200 to cause these extra configured resources to be released 625.

FIG. 6B shows an example timing diagram where the UE 300 may send the information on an unused CG resource/occasion 605 in one CG periodicity 610 to the gNB 200. In the example of FIG. 6B, a release indication 620 is used to release the resources, which is only one way of several ways that the gNB 200 may be instructed to release CG resource(s)/CG occasion(s), as will be subsequently explained. Generally, the UE 300 may send information about unused CG resource(s) (i.e., the remaining four CG occasions 605) and the related CG periodicities 610 to the gNB 200 to release the CG resources. The released CG resource(s) 625 may then be used for other purposes, such as by other UEs 300 or other services. Eight CG occasions 605 may be configured in each CG periodicity 610. In the example of FIG. 6B, the data may be transmitted completely in the first four CG occasions 605 such that no further data may be transmitted on the remaining four CG occasions 605. In this case, the UE 300 may send the information about unused CG resource(s) to the gNB 200 to release the resources of the remaining four CG occasions 605.

The UE 300 may send the information about the remaining, unused four CG occasions 605 to the gNB 200 by MAC CE to release the remaining CG resource(s). In this example, the remaining CG resource(s) may indicated by: (1) the number of remaining, unused CG occasion(s) 605 to be released 625; (2) the time (e.g., reference frame, reference slot, and/or reference symbol) after which any remaining CG occasion(s) 605 may be released 625; or (3) a zero byte MAC CE (i.e., only a MAC CE header or a specific LC-ID) to indicate that the CG occasion(s) are released 625 from the time that the zero byte MAC CE is received.

The reference time may be established as a time nearest preceding or nearest following the transmission of the delay report 420/520, which may be indicated by at least one of: the start boundary of an indicated SFN, the end boundary of an indicated SFN, the SFN number, the LSB (least n significant bit) of an SFN, a slot number, or a symbol number; where n may be an integer number.

Alternatively, the UE 300 may send the information on the remaining, unused four CG occasions 605 to the UE 300 lower layer (e.g., L1) to trigger the lower layer to send UCI to release the remaining CG resource(s). In this example, the remaining CG resource(s) may be indicated by: (1) the number of remaining, unused CG occasion(s) to be released 625; (2) the time (e.g., reference frame, reference slot, and/or reference symbol) after which any remaining CG occasion(s) may be released 625; or (3) a release indication 620 to indicate that the remaining CG occasion(s) may be released 625 from the time the release indication 620 is received.

FIG. 6C shows an example timing diagram where the UE 300 may send information about unused CG resource(s) in three CG periodicities 610 to the gNB 200. Generally, the UE 300 may send information about unused CG resource(s) (i.e., the remaining four CG occasions 605) and the related CG periodicities 610 to the gNB 200 to release the CG resources. The released CG resource(s) 625 may then be used for other purposes, such as by other UEs 300 or other services. Again, eight CG occasions 605 may be configured for each CG periodicity 610. In the example of FIG. 6C, the data may be transmitted completely in the first four CG occasions 605 such that no further data may be transmitted in the remaining four CG occasions 605. The UE 300 may predict that the same volume of data may be transmitted in the subsequent two CG periodicities 610 (i.e., the last four CG occasions 605 may not be used in the subsequent two CG periodicities 610). Anticipating this scenario, the UE 300 may send the information about unused CG resource(s) (i.e., the remaining four CG occasions 605) and the related CG periodicities 610 to the gNB 200 to release the resources of the four remaining CG occasions 605 of the two CG periodicities 610.

The UE 300 may send the information on the remaining, unused four CG occasions 605 and the associated CG periodicities 610 to the gNB 200 by MAC CE to release the remaining CG resource(s). In this example, the remaining CG resource(s) may be indicated by the number of remaining, unused CG occasions 605 to be released 625 and/or the number of related CG periodicities 610.

Alternatively, the UE 300 may send the information on the remaining, unused four CG occasions 605 and the associated CG periodicities 610 to the UE 300 lower layer (e.g., L1) to trigger the lower layer to send UCI to release the remaining CG resource(s). In this example, the remaining CG resource(s) may be indicated by the number of remaining, unused CG occasions 605 to be released 625 and/or the number of related CG periodicities 610.

FIG. 6D shows an example timing diagram where the UE 300 may send information about unused CG resource(s) in three CG periodicities 610 to the gNB 200. As previously stated, the UE 300 may send information about unused CG resource(s) (i.e., the remaining four CG occasions 605) and the related CG periodicities 610 to the gNB 200 to release the CG resources. The released CG resource(s) 625 may then be used for other purposes, such as by other UEs 300 or other services. Again, eight CG occasions 605 may be configured for each CG periodicity 610. In the example of FIG. 6D, the data may be transmitted completely in the first four CG occasions 605 such that no further data may be transmitted in the remaining four CG occasions 605. The UE 300 may predict that no data will be transmitted at all in the subsequent two CG periodicities 610. Anticipating this scenario, the UE 300 may send the information about unused CG resource(s) (e.g., the remaining four CG occasions 605) and related CG periodicities 610 to the gNB 200 to release the resources of the four remaining CG occasions 605 and all CG occasions 605 of the two subsequent CG periodicities 610. The released CG resource(s) 625 may then be used for other purposes, such as by other UEs 300 or other services.

The UE 300 may send the information on the remaining, unused four CG occasions 605 and the two subsequent CG periodicities 610 to the gNB 200 by MAC CE to release the remaining CG resource(s). In this example, the remaining CG resource(s) may be indicated by: (1) the number of remaining CG occasion(s) 605 to be released 625 and/or the number of CG periodicities 610 to be released 625; (2) the time after which any remaining CG occasion(s) 605 may be released 625 and the time duration that the CG may be released; (3) a specified time duration may be used to indicate that the CG resource(s) may be released 625 from the time that the MAC CE is received and for the specified time duration; or (4) a start time and a specified time duration may be used to indicate that the CG resource(s) may be released 625 from the start time and for the specified time duration.

Alternatively, the UE 300 may send the information about the remaining, unused four CG occasions 605 to the UE 300 lower layer (e.g., L1) to trigger the lower layer to send UCI to release the remaining CG resource(s). In this example, the remaining CG resource(s) may be indicated by: (1) the number of remaining, unused CG occasion(s) to be released 625 and/or the number of CG periodicities 610 to be released 625; (2) the time (e.g., reference frame, reference slot, and/or reference symbol) after which any remaining CG occasion(s) may be released 625 and a time duration that the CG resource is released 625; (3) a specified time duration may be used to indicate that the CG resource(s) may be released 625 for the specified duration from the time that the UCI is received; or (4) a start time and a specified time duration may be used to indicate that the CG resource(s) may be released 625 from the start time and for the specified time duration.

FIG. 6E shows an example timing diagram where the UE 300 may send information about unused CG resource(s) in two CG periodicities 610 to the gNB 200. Here again, eight CG occasions 605 may be configured for each CG periodicity 610. In the example of FIG. 6E, the data may be transmitted completely in the first eight CG occasions 605. The UE 300 may predict that no data may be transmitted in the subsequent two CG periodicities 610. Anticipating this scenario, the UE 300 may send the information about unused CG resource(s) to the gNB 200 to release the resources of the two subsequent CG periodicities 610. The released 625 CG resource(s) of the two subsequent CG periodicities 610 may then be used for other purposes, such as by other UEs 300 or other services.

The UE 300 may send the information on the two subsequent, unused CG periodicities 610 to the gNB 210 by MAC CE to release the remaining CG resource(s). In this example, the CG resource(s) may be indicated by: (1) the number of CG periodicities 610 to be released 625; (2) the time after which the CG resource(s) may be released 625 and the time duration that the CG resource(s) may be released 625; (3) a specified time duration that may be used to indicate that the CG resource(s) may be released 625 from the time that the MAC CE is received and for the specified time duration; or (4) a start time and a specified time duration may be used to indicate that the CG resource(s) may be released 625 from the start time and for the specified time duration.

Alternatively, the UE 300 may send the information on the two subsequent, unused CG periodicities 610 to the gNB 200 by sending to the lower layer (e.g., L1) to trigger the lower layer to send UCI to release the remaining CG resource(s). In this example, the remaining CG resource(s) may be indicated by: (1) the number of CG periodicities 610 to be released 625; (2) the time (e.g., reference frame, reference slot, and/or reference symbol) after which any remaining CG occasion(s) may be released 625; (3) a specified time duration may be used to indicate that the CG resource(s) may be released 625 for the specified duration from the time that the UCI is received; or (4) a start time and a specified time duration may be used to indicate that the CG resource(s) may be released 625 from the start time and for the specified time duration.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for delay reporting of buffered data in a wireless communication system comprising a user equipment (UE) having a buffer and a base station, the method comprising: transmitting a buffered data delay reporting indication to the UE; and receiving a delay report of buffered data from the UE, wherein the delay report of buffered data identifies one or more of: a first time duration from a first occasion a packet arrived in the buffer to a second occasion in which the delay report of buffered data was transmitted, a second time duration from the first occasion a packet arrived in the buffer to a third occasion that is indicated by a reference time, a first remaining time duration from the second occasion in which the delay report of buffered data was transmitted to the base station to a third occasion that an access network packet delay budget (AN PDB) is reached, a second remaining time duration from a fourth occasion that is indicated by the reference time to the third occasion that an AN PDB is reached, a third time duration from the second occasion the delay report of buffered data was transmitted to an expiration time of a packet discard timer, or a fourth time duration from the fourth occasion that is indicated by the reference time to the expiration time of the packet discard timer.

A second aspect includes the method of the first aspect wherein the buffered data delay reporting indication is sent by a system information block (SIB).

A third aspect includes the method of the first or second aspects, wherein the buffered data delay reporting indication is sent by a unicast radio resource control (RRC) message on a per UE basis, a per data radio bearer (DRB) basis, a per logical channel group (LCG) basis, or a per logical channel basis.

A fourth aspect includes the method of any preceding aspect, wherein the delay report of buffered data is received via a buffer status report (BSR).

A fifth aspect includes the method of any preceding aspect, wherein the delay report of buffered data comprises: multiple data packets having different delays; and a largest value of elapsed time or a least remaining time.

A sixth aspect includes the method of any preceding aspect, wherein the reference time can be indicated by at least one of the following: a start boundary of an indicated system frame number (SFN), an end boundary of an indicated SFN, SFN number, the LSB (least n significant bit) of the SFN, slot information, a CG start occasion, a connected mode discontinuous reception (C-DRX) start occasion, a periodical delay report start occasion, or a pre-defined periodical reference time.

A seventh aspect includes a method for delay reporting buffered data in a wireless communication system comprising a user equipment (UE) having a buffer and a base station, the method comprising: receiving a buffered data delay reporting support indication from the UE; transmitting a buffered data delay reporting configuration to the UE that configures a report type to a periodical report or an event report; and receiving a delay report of buffered data based on the configured report type, wherein the delay report of buffered data identifies one or more of: a first time duration from a first occasion a packet arrived in the buffer to a second occasion in which the delay report of buffered data was transmitted, a second time duration from the first occasion a packet arrived in the buffer to a third occasion that is indicated by a reference time, a first remaining time duration from the second occasion in which the delay report of buffered data was transmitted to the base station to a third occasion that an access network packet delay budget (AN PDB) is reached, a second remaining time duration from a fourth occasion that is indicated by the reference time to the third occasion that an AN PDB is reached, a third time duration from the second occasion the delay report of buffered data was transmitted to an expiration time of a packet discard timer, or a fourth time duration from the fourth occasion that is indicated by the reference time to the expiration time of the packet discard timer.

An eighth aspect includes the method of any preceding aspect, wherein in response to the report type being a periodical report: receiving the delay report of buffered data according to a periodicity configured by the buffered data delay reporting configuration.

A ninth aspect includes the method of any preceding aspect, wherein in response to the report type being an event report: receiving the delay report of buffered data when an event, configured by the buffered data delay reporting configuration, is triggered.

A tenth aspect includes the method of any preceding aspect wherein the event is reported via a buffer status report (BSR) when: a buffered time of one or more packets is larger than a preconfigured threshold, or a remaining time for buffered data transmission is less than a preconfigured threshold.

An eleventh aspect includes the method of any preceding aspect, wherein the buffered data delay reporting supporting indication is received via a UECapability Information message.

A twelfth aspect includes the method of any preceding aspect, wherein the delay report of buffered data comprises: multiple data packets having different delays; and a largest value of elapsed time or a least remaining time.

A thirteenth aspect includes the method of any preceding aspect, wherein in response to the report type being an event report: a report interval is configured by the buffered data delay reporting configuration.

A fourteenth aspect includes the method of any preceding aspect, further comprising: sending the delay report of buffered data with a time interval larger than or equal to the report interval.

A fifteenth aspect includes the method of any preceding aspect, wherein in response to the report type being an event report: a delay report prohibit timer is configured by the buffered data delay reporting configuration.

A sixteenth aspect includes the method of any preceding aspect, wherein receiving the delay report of buffered data only when the delay report prohibit timer is expired or not running.

A seventeenth aspect includes the method of any preceding aspect, wherein the reference time can be indicated by at least one of the following: a start boundary of an indicated system frame number (SFN), an end boundary of an indicated SFN, an SFN number, an LSB (least n significant bit) of the SFN, slot information, a CG start occasion, a connected mode discontinuous reception (C-DRX) start occasion, a periodical delay report start occasion, or a pre-defined periodical reference time.

An eighteenth aspect includes a method of releasing resources in a wireless communication system comprising a user equipment (UE) and a base station, the method comprising: receiving information specifying an unused resource from the UE; and releasing the unused resource in response to the information.

A nineteenth aspect includes the method of any preceding aspect, wherein the information is a media access control (MAC) control element (CE) that indicates one or more configured grant (CG) occasions in one CG periodicity to be released from a time the MAC CE is received.

A twentieth aspect includes the method of any preceding aspect, wherein the information is a media access control (MAC) control element (CE) that indicates one or more configured grant (CG) occasions in one CG periodicity to be released from a time indicated by a time field in the MAC CE.

A twenty-first aspect includes the method of any preceding aspect, wherein the information further specifies a number of unused configured grant (CG) occasions to be released to UE lowers, and UE lower send the information to gNB by UCI.

A twenty-second aspect includes the method of any preceding aspect, wherein the information further specifies CG resource in a number of CG periodicities to be released, wherein a CG periodicity comprises a plurality of CG occasions.

A twenty-third aspect includes the method of any preceding aspect, wherein the information further specifies a reference frame, reference slot, and/or reference symbol after which any remaining CG occasions are to be released.

A twenty-fourth aspect includes the method of any preceding aspect, wherein the information is received at a lower layer, the unused resource is a CG resource, and the method further comprises: sending an uplink control information (UCI) to release the CG resource.

A twenty-fifth aspect includes the method of any preceding aspect, wherein the information further specifies a number of unused CG occasions to be released.

A twenty-sixth aspect includes the method of any preceding aspect, wherein the information further specifies a number of CG periodicities to be released, wherein a CG periodicity comprises a plurality of CG occasions.

A twenty-seventh aspect includes the method of any preceding aspect, wherein the information further specifies a reference frame, reference slot, and/or reference symbol after which any remaining CG occasions are to be released.

A twenty-eighth aspect includes the method of any preceding aspect, wherein the information further specifies a release indication that indicates one or more CG occasions to be released from a time the release indication is received.

A twenty-ninth aspect includes the method of any preceding aspect, further comprising: determining a HARQ process ID for an M^{th} CG occasion in the N^{th} CG periodicity, where M and N are both integers and both greater than or equal to zero, according to: HARQ Process ID= [nrofCG-Occasions*N+M] modulo nrofHARQ-Processes+harq-ProcID-Offset wherein: nrofCG-Occasions is a number of CG occasions in a CG periodicity configured by the base station, nrofHARQ-Processes is a number of configured HARQ processes for the CG and/or CG occasions configured by the base station, and harq-ProcID-Offset is an offset of the HARQ process configured by the base station, which is used to determine the minimal HARQ process ID used for the CG and/or CG occasions, and a default harq-ProcID-Offset is zero if the harq-ProcID-Offset is not provided.

A thirtieth aspect includes a device for wireless communication comprising: a processor; and a memory in communication with the processor, the memory storing a plurality of instructions executable by the processor to cause the device to: implement the method of any preceding aspect.

A thirty-first aspect includes a non-transitory computer-readable medium comprising instructions operable, when executed by one or more processors, to: implement the method of any previous aspect.

1. A method for delay reporting of buffered data comprising:
transmitting, by a base station, a buffered data delay reporting information to a UE; and
receiving a delay report of buffered data from the UE, wherein the delay report of buffered data includes:
a time duration from an occasion the delay report of buffered data was transmitted to an expiration time of a packet discard timer.

2. The method of claim 1, wherein
the buffered data delay reporting information is associated with a logical channel group (LCG) and is sent by a radio resource control (RRC) message.

3. The method of claim 1, wherein
the time duration comprises:
a least remaining time of multiple data packets associated with a logical channel group (LCG) when the multiple data packets are buffered for the LCG.

4. The method of claim 1, wherein the delay report of buffered data is received by a delay report medium access control control element (MAC CE) associated with a logical channel group (LCG), wherein the MAC CE includes at least one of: a buffer size, an identification (ID) of the LCG, or a remaining time before the packet discard timer expires.

5. The method of claim 1, the method further comprises:
receiving a buffered data delay reporting support indication from the UE by a UE capability information message.

6. A method for delay reporting of buffered data comprising:
receiving a buffered data delay reporting information from a base station; and
transmitting, by a user equipment (UE), a delay report of buffered data to the base station, wherein the delay report of buffered data includes:
a time duration from an occasion the delay report of buffered data was transmitted to an expiration time of a packet discard timer.

7. The method of claim 6, wherein
the buffered data delay reporting information is associated with a logical channel group (LCG) and is received by a radio resource control (RRC) message.

8. The method of claim 6, wherein
the time duration comprises:
a least remaining time of multiple data packets associated with a logical channel group (LCG) when the multiple data packets are buffered for the LCG.

9. The method of claim 6, wherein the delay report of buffered data is transmitted by a delay report medium access control control element (MAC CE) associated with a LCG, wherein the MAC CE includes at least one of: a buffer size, an ID of LCG, or a remaining time before the packet discard timer expires.

10. The method of claim 6, wherein the delay report of buffered data is sent when a remaining time for buffered data transmission is less than a preconfigured threshold.

11. The method of claim 6, the method further comprises:
transmitting a buffered data delay reporting support indication to the base station by a UE capability information message.

12. A device for wireless communication comprising:
a processor; and
a memory in communication with the processor, the memory storing a plurality of instructions executable by the processor to cause the device to:
implement the method of claim 1.

13. A non-transitory computer-readable medium comprising instructions operable, when executed by one or more processors, to:
implement the method of claim 1.

14. A device for wireless communication comprising:
a processor; and
a memory in communication with the processor, the memory storing a plurality of instructions executable by the processor to cause the device to:
implement the method of claim 6.

15. A non-transitory computer-readable medium comprising instructions operable, when executed by one or more processors, to:
implement the method of claim 6.
